(19) United States
(12) Patent Application Publication
(10) Pub. No.: US 2008/0184023 A1
(43) Pub. Date: Jul. 31, 2008

(54) Computer platform boot block program corruption recovery handling method and system

(75) Inventor: Wen-Hsin Shih, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/701,136

(22) Filed: Jan. 31, 2007

(51) Int. Cl. G06F 9/00

(52) U.S. Cl. 713/2

(57) ABSTRACT

A computer platform boot block program corruption recovery handling method and system is proposed, which is designed for integration to a computer platform for providing the BIOS (Basic Input/Output System) of the computer platform with a boot block program corruption recovery handling function that is characterized by the partition of a backup handling program storage area from the BIOS storage space, such that at the start of the computer platform, the backup handling program stored in this area is first executed to check whether the boot block program in the BIOS is in good executable condition. If not, a backup copy of the boot block program is downloaded into the boot block so as to recover the corrupted program code therein. This feature can help enhance the reliability of operation of the computer platform and allows the implementation to be more simple and cost-effective than prior art.

### BACKGROUND OF THE INVENTION

1. Field of the Invention

This invention relates to information technology (IT), and more particularly, to a computer platform boot block program corruption recovery handling method and system which is designed for use with a computer platform that is equipped with a boot block in a boot control unit, such as BIOS (Basic Input/Output System), for providing the boot block program with a corruption recovery handling function.

2. Description of Related Art

BIOS (Basic Input/Output System) is a boot control unit that is widely utilized on PC-based computer platforms and implemented with computer code for controlling the boot of the computer platform. In practice, the BIOS is integrated together with the CPU to the system motherboard for providing the computer platform with a set of boot control functions, including initialization of hardware components and peripheral devices, executing POST (Power On Self Test) procedures, and loading operating system. Fundamentally, the BIOS allows the hardware devices to operate under control of the operating system.

In actual applications, however, the BIOS code could be corrupted and make the computer platform unable to be booted up. Presently, there are two solutions to this problem. The first solution is to install two identical BIOS chips on the motherboard, one of which is preset to serve the intended BIOS functionality after the start of the computer platform, while the other serves as a backup such that in the event of a failure to the active BIOS chip, the backup one can take over and thus allows the computer platform to continue to operate normally. One drawback to this solution, however, is that the installation of the backup BIOS chip would considerably increase hardware cost.

The second solution is to utilize just one BIOS chip and partition its storage space into two areas, respectively used for storing two identical copies of the same BIOS code, one of which is preset to serve the intended BIOS functionality after the start of the computer platform, while the other copy serves as a backup such that in the event of a failure to the active copy of BIOS code, the backup one can take over and thus allows the computer platform to continue to operate normally. One drawback to this solution, however, is that its implementation requires the use of complicated timing circuitry and switching mechanism to switch the failed BIOS code over to the backup one, and therefore is quite difficult and costly to realize.

Moreover, BIOS storage space is typically partitioned into two blocks, including a boot block and an operation block, wherein the operation block is used for storing a set of operation programs, including, for example, a POST (Power On Self Test) program and an operating system loader program; while the boot block is used for storing a boot block program which can be activated to execute at each power-on or restart of the computer platform for performing a boot procedure and checking whether each operation program stored in the operation block is good and executable; and if not, capable of performing a recovery procedure to recover the corrupted operation program. In the application of the computer platform, the boot block is typically fixed and not to be modified after shipment, but the operation block may be modified by the customers. However, the program code stored in the boot block might be damaged due to human errors in operation or virus attack. Presently, one solution to this problem is to replace the entire BIOS chip with a new one, but this solution is apparently quite inconvenient to implement and would significantly increase hardware and maintenance costs.

### SUMMARY OF THE INVENTION

It is therefore an objective of this invention to provide a computer platform boot block program corruption recovery handling method and system which can provide a corruption recovery handling function to the boot block in the BIOS-based boot control unit with a less complicated architecture and reduced hardware cost.

The computer platform boot block program corruption recovery handling method and system according to the invention is designed for use with a computer platform that is equipped with a boot block program in a boot control unit, such as BIOS, for providing the boot block program with a corruption recovery handling function.

The computer platform boot block program corruption recovery handling method according to the invention comprises: (M1) at each start of the computer platform, checking whether the boot block program stored in the boot block is executable; if not, issuing a boot block error message; and (M2) responding to the boot block error message by performing a boot block program recovery procedure to download a backup copy of boot block program into the boot block.

In architecture, the boot block program corruption recovery handling system according to the invention comprises: (A) a boot block error checking module, which is capable of being activated in response to each start of the computer platform by checking whether the boot block program stored in the boot block is executable; and if not, capable of issuing a boot block error message; (B) a backup boot block program storage module, which is used to prestore a backup copy of the boot block program stored in the boot block; and (C) a boot block program recovery module, which is capable of responding to the boot block error message from the boot block error checking module by performing a boot block program recovery procedure to download the backup copy of boot block program from the backup boot block program storage module into the boot block to thereby recover the boot block program in the boot block.

The computer platform boot block program corruption recovery handling method and system according to the invention is characterized by the partition of a backup handling program storage area from the BIOS storage space, such that at the start of the computer platform, the backup handling program stored in this area is first executed to check whether the boot block program in the BIOS is in good executable condition. If not, a backup copy of the boot block program is downloaded into the boot block so as to recover the corrupted program code therein. This feature can help enhance the reliability of operation of the computer platform and allows the implementation to be more simple and cost-effective than prior art.

### BRIEF DESCRIPTION OF DRAWINGS

The invention can be more fully understood by reading the following detailed description of the preferred embodiments, with reference made to the accompanying drawings, wherein:

FIG. 1 is a schematic diagram showing the application of the computer platform boot block program corruption recovery handling system of the invention with a computer platform;

FIG. 2 is a schematic diagram showing the integration of the computer platform boot block program corruption recovery handling system of the invention to a BIOS-based boot control unit;

FIG. 3 is a schematic diagram showing a modularized architecture of the computer platform boot block program corruption recovery handling system of the invention; and

FIG. 4 is an activity diagram showing the activities performed by the computer platform boot block program corruption recovery handling system of the invention.

### DETAILED DESCRIPTION OF PREFERRED EMBODIMENTS

The computer platform boot block program corruption recovery handling method and system according to the invention is disclosed in full details by way of preferred embodiments in the following with reference to the accompanying drawings.

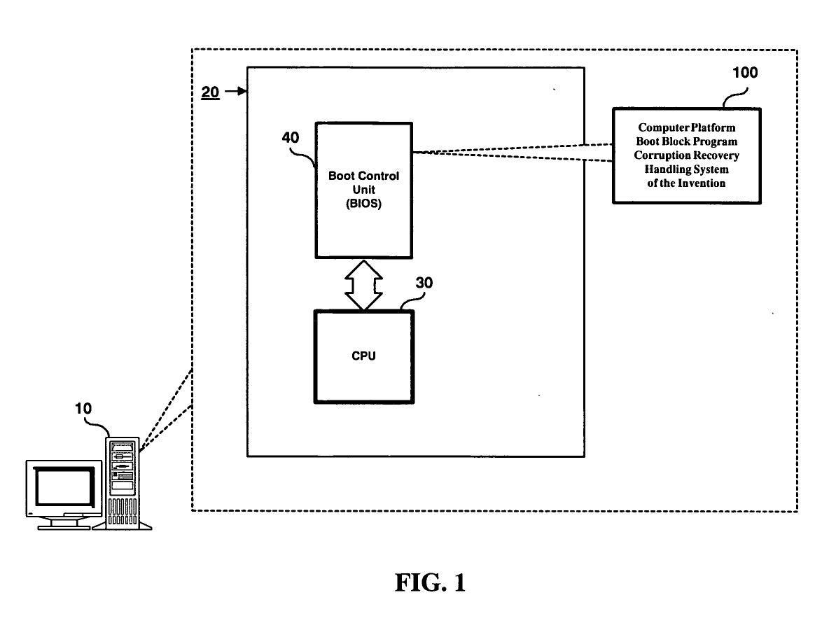

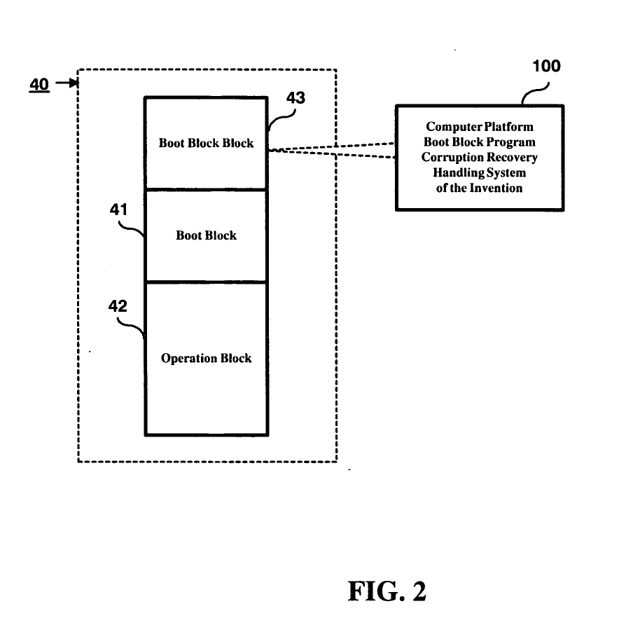

FIG. 1 is a schematic diagram showing the application of the computer platform boot block program corruption recovery handling system according to the invention (which is here encapsulated in a box indicated by the reference numeral 100). As shown, the boot block program corruption recovery handling system of the invention 100 is designed for use with a computer platform 10, such as a network server, a desktop computer, a notebook computer, or a palmtop computer, which is based on a motherboard 20 that is equipped with a CPU (Central Processing Unit) 30 and a boot control unit 40, such as a BIOS (Basic Input/Output System) based boot control unit. In practice, the BIOS-based boot control unit 40 is typically implemented with program code burned to a flash memory, and whose storage space is partitioned into at least one boot block 41 and at least one operation block 42, as illustrated in FIG. 2. The boot block 41 is used for storing a boot block program which can be activated to execute at each power-on or restart of the computer platform 10 for performing a boot procedure and checking whether each operation program stored in the operation block 42 is good and executable; and if NOT, capable of performing a recovery procedure to recover the corrupted operation program. The operation block 42 is used for storing a set of operation programs, including, for example, a POST (Power On Self Test) program and an operating system loader program.

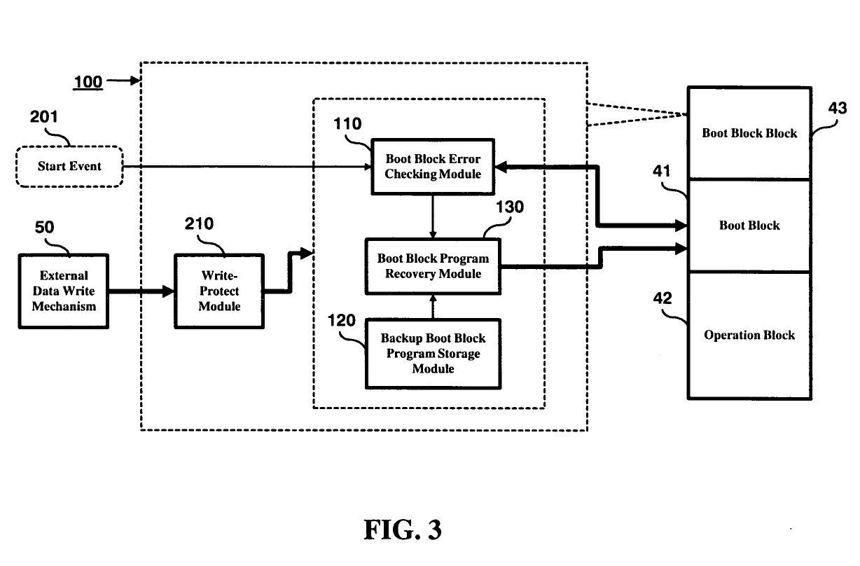

As shown in FIG. 3, the boot block program corruption recovery handling system of the invention 100 is based on a modularized architecture which comprises: (A) a boot block error checking module 110; (B) a backup boot block program storage module 120; and (C) a boot block program recovery module 130; and can further optionally comprise a write-protect module 210. In practice, these modules 110, 120, 130 can be implemented with computer program code and integrated to a predefined storage area, called a backup handling program storage area 43, in the BIOS-based boot control unit 40; and the backup handling program storage area 43 is preset to be the first program code to be executed right after the power-on or restart of the computer platform 10. Firstly, the respective attributes and behaviors of these constituent modules are described in details in the following.

The boot block error checking module 110 is capable of being activated in response to each power-on or restart of the computer platform 10 (i.e., when a start event 201 occurs on the computer platform 10) by checking whether the program code stored in the boot block 41 of the BIOS-based boot control unit 40 is good and executable; if NOT, capable of issuing a boot block error message to the boot block program recovery module 130, and whereas if YES, capable of issuing a boot block good message to the CPU 30, activating the CPU 30 to execute the program code stored in the boot block 41 of the BIOS-based boot control unit 40 and then execute the operation programs stored in the operation block 42 to complete the booting of the computer platform 10. In practical implementation, for example, the boot block error checking module 110 can utilize a checksum method for checking whether the program code in the boot block 41 is good and executable.

The backup boot block program storage module 120 is used to prestore a backup copy of the boot block program stored in the boot block 41 of the BIOS-based boot control unit 40. In practical implementation, for example, this backup boot block program storage module 120 can be either a predefined storage area in the backup handling program storage area 43, or a storage area in an external storage device such as an optical disc.

The boot block program recovery module 130 is capable of responding to the boot block error message from the boot block error checking module 110 by performing a boot block program recovery procedure, whereby the backup copy of boot block program stored in the backup boot block program storage module 120 is downloaded into the boot block 41 to thereby recover the corrupted program code in the boot block 41.

The write-protect module 210 is a hardware-based module which is capable of protecting the program code stored in the backup handling program storage area 43 (i.e., the program code of the boot block program corruption recovery handling system of the invention 100) against unauthorized access. In practice, for example, this write-protect module 210 can be implemented with a set of hardware jumpers, which can be flipped by the user in predefined patterns to either allow or disallow an external data write mechanism 50 to gain access to and change the program code stored in the backup handling program storage area 43.

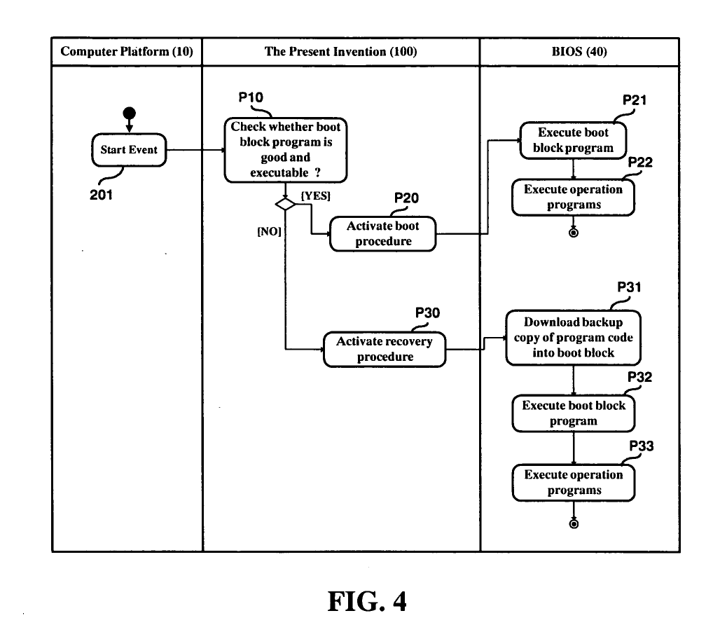

The following is a detailed description of a practical application example of the boot block program corruption recovery handling system of the invention 100 during actual operation, which is described with reference to the activity diagram of FIG. 4.

At the power-on or restart of the computer platform 10 (i.e., a start event 201 occurs on the computer platform 10), it causes the CPU 30 to first execute the program code stored in the backup handling program storage area 43 of the BIOS-based boot control unit 40 (i.e., the program code of the boot block program corruption recovery handling system of the invention 100). Firstly, the boot block error checking module 110 is activated to perform the activity P10 shown in FIG. 4 to check whether the program code stored in the boot block 41 of the BIOS-based boot control unit 40 is good and executable.

If YES, the boot block error checking module 110 issues a boot block good message to the CPU 30, whereby a boot procedure is activated (as the activity P20 shown in FIG. 4). The boot procedure includes a first step of executing the program code stored in the boot block 41 of the BIOS-based boot control unit 40 ((as the activity P21 shown in FIG. 4), and a second step of executing each of the operation programs stored in the operation block 42 (as the activity P22 shown in FIG. 4). This completes the boot of the computer platform 10.

On the contrary, if NOT, the boot block error checking module 110 issues a boot block error message to the boot block program recovery module 130, thereby activating the boot block program recovery module 130 to perform a boot block program recovery procedure (as the activity P30 shown in FIG. 4), which includes a step of downloading the backup copy of boot block program stored in the backup boot block program storage module 120 into the boot block 41 to thereby recover the corrupted program code in the boot block 41 (as the activity P31 shown in FIG. 4). After recovery, the recovered program code stored in the boot block 41 is then executed (as the activity P31 shown in FIG. 4), and subsequently, each of the operation programs stored in the operation block 42 is executed (as the activity P32 shown in FIG. 4) to complete the boot of the computer platform 10.

In conclusion, the invention provides a computer platform boot block program corruption recovery handling method and system, which is designed for use with a computer platform for providing the BIOS of the computer platform with a boot block program corruption recovery handling function, and which is characterized by the partition of a backup handling program storage area from the BIOS storage space, such that at the start of the computer platform, the backup handling program stored in this area is first executed to check whether the boot block program in the BIOS is in good executable condition. If not, a backup copy of the boot block program is downloaded into the boot block so as to recover the corrupted program code therein. This feature can help enhance the reliability of operation of the computer platform and allows the implementation to be more simple and cost-effective than prior art. The invention is therefore more advantageous to use than the prior art.

The invention has been described using exemplary preferred embodiments. However, it is to be understood that the scope of the invention is not limited to the disclosed embodiments. On the contrary, it is intended to cover various modifications and similar arrangements. The scope of the claims, therefore, should be accorded the broadest interpretation so as to encompass all such modifications and similar arrangements.

What is claimed is:

1. A computer platform boot block program corruption recovery handling method for use by a computer platform that is equipped with a boot control unit having a storage space partitioned into a boot block for storing a boot block program and an operation block for storing a set of operation programs;
the computer platform boot block program corruption recovery handling method comprising:
at each start of the computer platform, checking whether the boot block program stored in the boot block is executable; if not, issuing a boot block error message; and
responding to the boot block error message by performing a boot block program recovery procedure to download a backup copy of boot block program into the boot block.

2. The computer platform boot block program corruption recovery handling method of claim 1, which is implemented with a computer program for integration to a predefined backup handling program storage area in the boot control unit.

3. The computer platform boot block program corruption recovery handling method of claim 1, wherein the checking of whether the boot block program stored in the boot block is executable utilizes a checksum method.

4. A computer platform boot block program corruption recovery handling system for use with a computer platform that is equipped with a boot control unit having a storage space partitioned into a boot block for storing a boot block program and an operation block for storing a set of operation programs;
the computer platform boot block program corruption recovery handling system comprising:
a boot block error checking module, which is capable of being activated in response to each start of the computer platform by checking whether the boot block program stored in the boot block is executable; and if not, capable of issuing a boot block error message;
a backup boot block program storage module, which is used to prestore a backup copy of the boot block program stored in the boot block; and
a boot block program recovery module, which is capable of responding to the boot block error message from the boot block error checking module by performing a boot block program recovery procedure to download the backup copy of boot block program from the backup boot block program storage module into the boot block to thereby recover the boot block program in the boot block.

5. The computer platform boot block program corruption recovery handling system of claim 4, wherein the boot control unit is a BIOS (Basic Input/Output System) unit.

6. The computer platform boot block program corruption recovery handling system of claim 4, which is implemented with a computer program for integration to a predefined backup handling program storage area in the boot control unit.

7. The computer platform boot block program corruption recovery handling system of claim 4, further comprising:
a write-protect module for protecting the program code stored in the backup handling program storage area against unauthorized access.

8. The computer platform boot block program corruption recovery handling system of claim 7, wherein the write-protect module is a set of hardware jumpers.

9. The computer platform boot block program corruption recovery handling system of claim 4, wherein the boot block error checking module utilizes a checksum method for checking whether the program code stored in the boot block is executable.
